(19) United States
(12) Patent Application Publication
(10) Pub. No.: US 2007/0200524 A1
(43) Pub. Date: Aug. 30, 2007

(54) Vehicle seat comprising controlled actuator

(75) Inventors: Jean-Claude Robert, Le Raincy (FR); Raphael Devaux, Paris (FR)

Correspondence Address: Womble Carlyle Sandridge & Rice, PLLC;Attn: Patent Docketing 32nd Floor, P.O. Box 7037, Atlanta, GA, 30357-0037, US

(73) Assignee: PRECILEC, Auxerre (FR)

(21) Appl. No.: 10/570,484

(22) PCT Filed: Aug. 18, 2004
(86) PCT No.: PCT/FR04/02156

§ 371 Date: Nov. 28, 2006

(30) Foreign Application Priority Data
Sep. 3, 2003 (FR) 0310438

(51) Int. Cl. H02P 1/04

(52) U.S. Cl. 318/466

(57) ABSTRACT

The vehicle seat (10) comprises a seat structure (12), at least one element (14, 16) which is mobile relative to the structure (12) of the seat, at least one actuator (20, 22) for operating the or each mobile element (14, 16), means (24) for controlling the or each actuator (20, 22) in order to bring the seat into a set of predetermined configurations. Sequencing means (24) suitable for operating the control of the or each actuator (20, 22) in order to bring the seat into several different predetermined configurations in succession in accordance with a predetermined sequence of configurations with a predetermined hold time between each change of configuration.

The present invention relates to a vehicle seat of the type comprising a seat structure, at least one element which is mobile relative to the structure of the seat, at least one actuator for operating the or each mobile element, and means for controlling the or each actuator in order to bring the seat into a set of predetermined configurations.

Long-haul aeroplanes for transporting passengers enable very long distances to be travelled non-stop. Thus, journeys are very long and may exceed twelve hours.

During the flight, the passengers remain seated in their seats and move around very little.

The altitude, combined with fatigue and food to which they are often unaccustomed, causes vascular disorders, and especially thromboses, in some passengers.

In order to avoid such disorders, passengers are recommended to leave their seats regularly to walk around a little in the aeroplane in order to promote blood circulation. However, such movements are not always possible and some passengers decide not to get up so as not to disturb their neighbours.

What is more, seats are currently equipped with electrical actuators enabling specific mobile portions of the seat, and especially a leg-rest and the back, to be moved. Thus, passengers can configure their seats so as to find a pleasant position. Passengers therefore have little inclination to move around in the aeroplane.

The object of the invention is to propose a solution enabling the number of thrombosis disorders during long-haul flights to be reduced.

To that end, the invention relates to a vehicle seat of the above-mentioned type, characterized in that it comprises sequencing means suitable for operating the control of the or each actuator in order to bring the seat into several different predetermined configurations in succession in accordance with a predetermined sequence of configurations with a predetermined hold time between each change of configuration.

According to particular embodiments, the seat comprises one or more of the following features:
the predetermined hold time between each change of configuration is from 1 to 30 minutes;
the sequencing means are suitable for the repeated implementation of the predetermined sequence of configurations with a predetermined idle time between each implementation of the predetermined sequence of configurations;
the predetermined idle time between each implementation of the predetermined sequence of configurations has a duration greater than the predetermined hold time between each change of configuration;
the idle time has a duration of from 30 minutes to 2 hours;
the predetermined sequence of configurations comprises first of all a succession of configurations according to a predetermined order followed by a succession of the same configurations according to the reverse predetermined order; and
it comprises at least one auxiliary device controlled by the control means, and the sequencing means are suitable for operating the control of the or each auxiliary device when a configuration is reached during the implementation of the predetermined sequence of configurations.

The invention will be better understood on reading the following description which is given purely by way of example and with reference to the drawings in which:

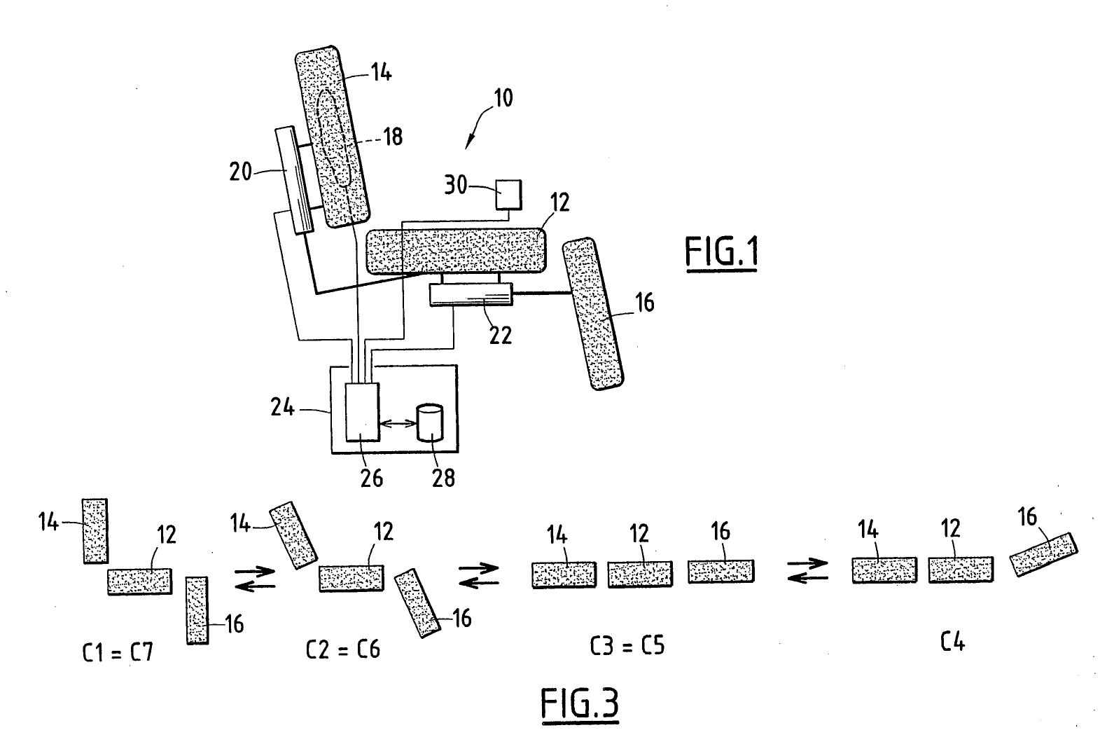

FIG. 1 is a schematic view of a vehicle seat according to the invention;

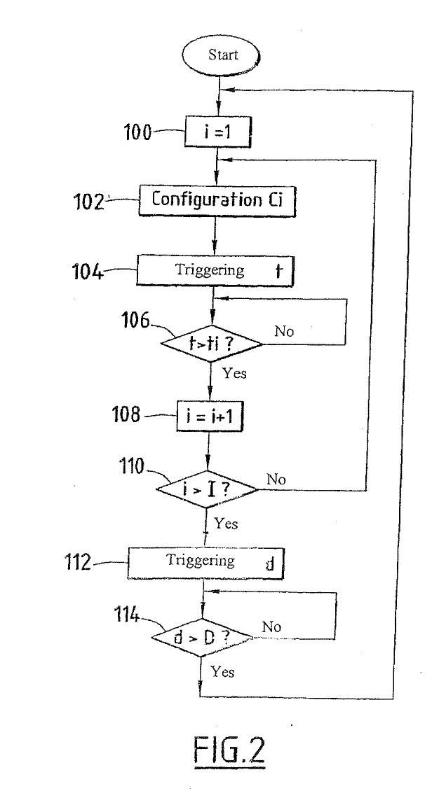

FIG. 2 is a flow chart of the operation algorithm of the seat according to the invention;

FIG. 3 is a view illustrating schematically four different configurations assumed in succession by the seat during the implementation of the algorithm illustrated in FIG. 2.

The seat 10 shown in FIG. 1 is, for example, a long-haul aeroplane seat. The seat comprises a squab 12 at a rear end of which a back 14 is articulated and at the front end of which a leg-rest 16 is articulated.

A massage device 18, which is formed, for example, by an inflatable and deflatable air cushion, is incorporated in the back 14.

An electrical actuator is associated with each mobile element of the seat in order to ensure the displacement thereof. Thus, an actuator 20 is installed between the squab 12 and the back 14 while an actuator 22 is installed between the squab 12 and the leg-rest 16.

The back 14 is displaceable between a raised position substantially perpendicular to the squab 12 and a lowered position in which the back is horizontal and forms an extension of the squab 12.

The leg-rest 16 is displaceable between a generally vertical lowered position extending below the squab 12 and a raised position in which the end of the leg-rest extends at a level higher than that of the squab 12, the leg-rest and the squab delimiting an angle of, for example, 30°.

The actuators 20 and 22 are connected to a central control unit 24 comprising means for supplying them with electric current so that the actuators move in one direction or the other.

As is known per se, each actuator is equipped with a potentiometer enabling its current position to be determined. The data coming from the potentiometers are transmitted to the central data control unit 24.

The central control unit 24 comprises a data-processing unit 26, such as a micro-controller, associated with storage means 28 for programs for operating the seat and for characteristic parameters defining predetermined configurations which can be occupied by the seat.

The unit 24 enables each actuator to be supplied in a given direction so that the actuator reaches a predetermined position peculiar to a target configuration. For that purpose, the data-processing unit continuously compares the value received from the potentiometer of the actuator in question with a characteristic parameter corresponding to the predetermined configuration required for the seat.

The central control unit 24 is connected to a control keyboard 30 comprising keys permitting independent operation in one direction or the other of each of the actuators 20 and 22.

The keyboard also comprises keys enabling the seat to be brought into different predetermined configurations. It also comprises a key for implementing a sequenced functioning of the seat, which enables thrombosis to be avoided.

Likewise, the massage device 18 is connected to the central control unit 24 in order for it to be started and stopped from a specific key of the keyboard 30.

According to the invention, the vehicle seat comprises sequencing means suitable for operating the control of the or each actuator in order to bring the seat into several different predetermined configurations in succession in accordance with a predetermined sequence of configurations with a predetermined delay between each change of configuration.

More precisely, a program, the algorithm of which is shown schematically in FIG. 2, is stored in the memory 28, as is also a sequencing table, such as Table 1, which shows the different configurations and their hold times. The data-processing unit is suitable for implementing the algorithm of FIG. 2 when a predetermined key of the keyboard 30 is pressed.

TABLE 1

| Configuration | Actuator 20 | Actuator 22 | State 18 | tᵢ |
|---|---|---|---|---|
| C₁ | 100 | 0 | off | 10′ |
| C₂ | 70 | 20 | active | 15′ |
| C₃ | 0 | 100 | off | 8′ |
| C₄ | 0 | 130 | off | 5′ |
| C₅ | 0 | 100 | off | 4′ |
| C₆ | 70 | 20 | active | 8′ |
| C₇ | 100 | 0 | off | 5′ |

The sequencing Table 1 comprises, for all of the predetermined configurations to be assumed by the seat in succession, the characteristic parameters of those configurations for the actuators 20 and 22. It also comprises the hold time tᵢ for each configuration Cᵢ.

The hold time tᵢ of a configuration is preferably from 1 minute to half an hour.

Likewise, the state of the massage device 18 for each configuration is given by the sequencing table.

Each of the configurations is marked from C₁ to C₇ in the example under consideration.

The algorithm implemented by the data-processing unit for the sequenced functioning of the seat is illustrated in FIG. 2.

When the sequenced functioning is operated, by pressing the appropriate key of the keyboard 26, a parameter i of a configuration counter is initialized at value 1 in step 100.

In step 102, the seat is immediately brought into the configuration Cᵢ. In the case in point, this is initially the configuration C₁. This configuration is such that the back and the leg-rest are upright, as illustrated in FIG. 3.

In order to bring the seat into this configuration, the parameters peculiar to the configuration that is to be reached are read from Table 1 and the actuators are brought into the corresponding desired position by implementing an algorithm known by the data-processing unit 26.

In step 104, a chronometer is triggered as soon as the seat has reached the configuration Cᵢ. In step 106, a test is carried out to determine whether the time t indicated by the chronometer for which the seat has been in configuration C₁ is greater than the hold time tᵢ indicated for this configuration in Table 1. As long as the time t is less than tᵢ, the test is carried out in a loop. The hold time is, for example, 10 minutes for configuration C₁ of the seat.

During this stage, each of the actuators 20 and 22 can be brought into play by an individual operation emanating from the keyboard 26. However, this possible modification of the configuration does not affect the later implementation of the sequencing method.

As soon as the time t is greater than the predetermined hold time tᵢ, the variable i of the counter is incremented in step 108. In step 110, a check is carried out to establish whether the variable i of the counter has reached a value I representing the maximum number of configurations in Table 1. If it has not done so, steps 102 to 108 are implemented for the following configuration mentioned in Table 1.

Thus, for example, starting from configuration C, described above, the seat is brought into a configuration C₂ illustrated in FIG. 3 in which the back is slightly folded back, for example by an angle of 30°, while the leg-rest is slightly raised, for example by an angle of 20°. The hold time in this configuration is set at 15 minutes. During these 15 minutes, the massage device 18 is activated automatically.

In configuration C₃, the back 14 and the leg-rest 16 are both horizontal and form an extension of the squab at each of its ends so that the passenger is lying completely flat. This configuration is held for 8 minutes while the massage device is off.

After the 8-minute hold in configuration C₃, the seat is brought automatically into configuration C₄ in which the leg-rest 16 is raised to the maximum extent and delimits an angle of 30° with the squab. The back 14 is maintained in the extension of the squab and the massage device is kept switched off.

After the 5-minute hold in this configuration, configurations C₅, C₆ and C₇ are assumed in succession by the seat.

These configurations correspond to configurations C₃, C₂ and C₁, respectively, defined above. Their hold times are, however, reduced and are set at 4, 7 and 5 minutes, respectively.

Thus, the configurations occupied in succession by the seat in accordance with a first order are occupied again in accordance with a reverse order.

When the seat has been brought into each of the configurations contained in the sequencing table, that is to say, when the test of step 110 is positive, a new chronometer is triggered in step 110. When the time d defined by this chronometer exceeds a predetermined time D defining an idle time during the test carried out in step 114, step 100 and the following steps are implemented again so that the seat is again brought sequentially into each of the predefined configurations in Table 1. The duration of the idle time D is preferably greater than the hold times tᵢ of the configurations used for the test of step 106. Thus, this time D is preferably from half an hour to two hours.

With such a seat, it will be appreciated that during long-haul flights the passenger, simply by pressing a predetermined key of the keyboard, can ensure that his seat changes configuration regularly, preventing the blood from accumulating in certain regions of the arterial and veinous network. Thus, the risks of thrombosis are reduced.

In addition, substantial time lapses separating the movements of the seat from a predetermined configuration into the following configuration prevent passengers from feeling that they are being constantly manhandled by their seats, while at the same time ensuring a regular change of position.

1. A vehicle seat comprising a seat structure, at least one element which is mobile relative to the structure of the seat, at least one actuator for operating the or each mobile element, and means for controlling the or each actuator in order to bring the seat into a set of predetermined configurations, wherein said vehicle seat comprises sequencing means suitable for operating control of the or each actuator in order to bring the seat into several different predetermined configurations in succession in accordance with a predetermined sequence of configurations with a predetermined hold time between each change of configuration.

2. A vehicle seat according to claim 1, wherein the predetermined hold time between each change of configuration is from 1 to 30 minutes.

3. A vehicle seat according to claim 1, wherein the sequencing means are suitable for repeated implementation of the predetermined sequence of configurations with a predetermined idle time between each implementation of the predetermined sequence of configurations.

4. A vehicle seat according to claim 3, wherein the predetermined idle time between each implementation of the predetermined sequence of configurations has a duration greater than the predetermined hold time between each change of configuration.

5. A vehicle seat according to claim 4, wherein the idle time has a duration of from 30 minutes to 2 hours.

6. A vehicle seat according to claim 1, wherein the predetermined sequence of configurations comprises a succession of configurations according to a predetermined order followed by a succession of the same configurations according to a reverse predetermined order.

7. A vehicle seat according to claim 1, wherein said seat comprises at least one auxiliary device controlled by the control means, and further wherein the sequencing means suitable for operating the control of the or each auxiliary device when a configuration is reached during the implementation of the predetermined sequence of configurations.

8. A vehicle seat according to claim 2, wherein the sequencing means are suitable for repeated implementation of the predetermined sequence of configurations with a predetermined idle time between each implementation of the predetermined sequence of configurations.

9. A vehicle seat according to claim 8, wherein the predetermined idle time between each implementation of the predetermined sequence of configurations has a duration greater than the predetermined hold time between each change of configuration.

10. A vehicle seat according to claim 4, wherein the idle time has a duration of from 30 minutes to 2 hours.

11. A vehicle seat according to claim 2, wherein the predetermined sequence of configurations comprises a succession of configurations according to a predetermined order followed by a succession of the same configurations according to a reverse predetermined order.

12. A vehicle seat according to claim 3, wherein the predetermined sequence of configurations comprises a succession of configurations according to a predetermined order followed by a succession of the same configurations according to a reverse predetermined order.

13. A vehicle seat according to claim 4, wherein the predetermined sequence of configurations comprises a succession of configurations according to a predetermined order followed by a succession of the same configurations according to a reverse predetermined order.

14. A vehicle seat according to claim 5, wherein the predetermined sequence of configurations comprises a succession of configurations according to a predetermined order followed by a succession of the same configurations according to a reverse predetermined order.

15. A vehicle seat according claim 2, wherein said seat comprises at least one auxiliary device controlled by the control means, and further wherein the sequencing means suitable for operating the control of the or each auxiliary device when a configuration is reached during the implementation of the predetermined sequence of configurations.

16. A vehicle seat according claim 3, wherein said seat comprises at least one auxiliary device controlled by the control means, and further wherein the sequencing means suitable for operating the control of the or each auxiliary device when a configuration is reached during the implementation of the predetermined sequence of configurations.

17. A vehicle seat according claim 4, wherein said seat comprises at least one auxiliary device controlled by the control means, and further wherein the sequencing means suitable for operating the control of the or each auxiliary device when a configuration is reached during the implementation of the predetermined sequence of configurations.

18. A vehicle seat according claim 5, wherein said seat comprises at least one auxiliary device controlled by the control means, and further wherein the sequencing means suitable for operating the control of the or each auxiliary device when a configuration is reached during the implementation of the predetermined sequence of configurations.

19. A vehicle seat according claim 6, wherein, said seat comprises at least one auxiliary device controlled by the control means, and further wherein the sequencing means suitable for operating the control of the or each auxiliary device when a configuration is reached during the implementation of the predetermined sequence of configurations.

20. A vehicle comprising a vehicle seat of claim 1.
